(19) United States
(12) Patent Application Publication
(10) Pub. No.: US 2006/0034748 A1
(43) Pub. Date: Feb. 16, 2006

(54) Device for providing improved combustion in a carbon black reactor

(76) Inventors: David R. Lewis, Acworth, GA (US); Barry J. Stagg, Acworth, GA (US)

Correspondence Address: NEEDLE & ROSENBERG, P.C., SUITE 1000, 999 PEACHTREE STREET, ATLANTA, GA, 30309-3915, US

(21) Appl. No.: 10/916,268

(22) Filed: Aug. 11, 2004

(51) Int. Cl. C09C 1/50

(52) U.S. Cl. 423/449.1

(57) ABSTRACT

An oxidant diffusion device for use in an axial flow tread carbon black reactor that is capable of providing improved uniformity in the physical and chemical profiles of the combustion gas produced in the combustion zone of a carbon black reactor. In one aspect, the oxidant diffusion device comprises a housing member having a distal end and a proximal end and further defining an internal cavity; an opening defined by the proximal housing end and in fluid communication with the internal cavity; a plurality of radial oxidant inlet apertures defined by the housing and in fluid communication with the internal cavity; and a plurality of axial oxidant inlet apertures defined by the distal housing end and in fluid communication with the internal cavity.

### FIELD OF THE INVENTION

This invention relates generally to the field of carbon black reactors and methods and apparatuses for improving the efficiency thereof.

### BACKGROUND OF THE INVENTION

In general, finer grade carbon blacks, i.e., those typically falling in the range of N100 series to the N300 series as measured by ASTM-D1765, are produced in axial tread carbon black reactors. This production process takes place via a mechanism commonly known as a pyrolysis reaction whereby carbonaceous feedstock, typically a heavy aromatic oil, is injected into a high temperature and high velocity gaseous environment created in a combustion zone upstream from the reaction zone. The gaseous combustion environment is the product of the lean combustion of a hydrocarbon fuel, such as natural gas, and an oxidant, typically pre-heated air.

As mentioned, axial tread carbon black reactors have two zones. The first zone is the combustion zone, which generates the gaseous combustion environment for the second zone, commonly referred to as the reaction zone, in which the carbonaceous feedstock is injected. In this reaction zone, the carbonaceous feedstock partially combusts with the residual oxygen present from the first zone and the remainder is pyrolized to form carbon black.

The combustion zone in an axial tread carbon black reactor typically comprises: (1) an oxidant introduction chamber, typically an overhead air pipe or duct, commonly called the bustle, (2) a bustle chamber, into which the bustle intersects perpendicularly, (3) a burner assembly, comprising a fuel pipe or spray nozzle that is inserted into the bustle chamber externally from the side or from the front face of the reactor; (4) a combustion choke which is a refractory diffusion ring at the end of the bustle chamber that serves to promote mixing of the fuel and oxidant; and (5) a combustion dwell section that is intended to allow residence time to complete the combustion process before the hot gases enter the choke section of the reaction zone where the carbonaceous feedstock is injected.

Generally, the production of a particular grade of carbon black is primarily controlled by adjusting the ratio of oil to oxidant. Lower ratios typically produce finer grades. In practice, the air rate is usually a fixed parameter and therefore only the oil rates are modified. Therefore, to maximize production rates, the air rates are set to the limit of the reactor system, based upon blower capacity and system pressure drops and then the oil rates are adjusted accordingly. Additionally, to maximize yields, i.e., the amount of carbon black product that is produced for a given rate of carbonaceous feedstock injected, it is desired to increase the temperature of the combustion gases in the first zone to its highest allowable level permitted by the reactor's refractory. This is achieved by controlling the ratio of fuel to air. Increasing the fuel equivalence ratio towards a maximum of 1:1, the point at which the amount of fuel is sufficient to consume all of the oxidant without leaving excess unreacted fuel, produces a richer flame in the combustion zone and tends to provide higher yields by providing relatively higher combustion gas temperatures. Similarly, these higher combustion gas temperatures allow for a higher rate of carbonaceous feedstock introduction into the reactor while maintaining the production of carbon black having the desired grade and properties.

Notwithstanding the above-mentioned benefits, an increase in the fuel to oxidant ratio alone also tends to reduce the residence time within the combustor section for mixing and thermal diffusion of the combustion gases which in turn leads to achieving lower than targeted reaction temperatures. This results in the production of non-uniform thermal and chemical profiles in the choke section of the reactor. The lower than targeted flame temperature also results in the need to reduce the oil rate in order to achieve the same desired grade of carbon black. Therefore, because a non-uniform combustion gas environment does have an adverse impact on the resultant heat release or flame temperature of the mixture and, subsequently, the optimum oil rate necessary for a given grade of carbon black, uniformity in the combustion environment is desirable in order to maximize the yield and production capacity of existing axial tread carbon black reactor technology.

Accordingly, the present disclosure provides inventive oxidant diffusion devices and methods for improving the uniformity of the combustion gas environment and thereby improving the yields and capacities of axial tread carbon black reactors.

### SUMMARY OF THE INVENTION

Among other aspects, the present invention is based upon an inventive oxidant diffusion device for use in axial tread carbon black reactors that is capable of improving the efficiency and yield of the pyrolysis reaction within the reactor.

In one aspect, the invention provides an oxidant diffusion device for use in a combustion zone of an axial tread carbon black reactor comprising a housing defining an internal cavity and having a distal end, an open proximal end, an exterior peripheral surface and a central longitudinal axis. The exterior peripheral surface of said housing member defines a plurality of first oxidant inlet ports that are positioned between the distal and proximal ends and that are in communication with the internal cavity of the housing. The distal end has an exterior face, an opposed interior face and defines a plurality of second oxidant inlet ports extending through the exterior face in communication with the internal cavity.

In a second aspect, the invention provides an oxidant diffusion device for use in a combustion zone of an axial tread carbon black reactor, comprising a housing member defining an internal cavity and having a distal end, an open proximal end, an exterior peripheral surface and a longitudinal axis. In this aspect, the exterior peripheral surface defines a plurality of oxidant inlet ports positioned between the distal and proximal ends and in communication with the internal cavity of the housing member.

In a third aspect, the invention provides a combustion system for producing a combustion gas in an axial tread carbon black reactor comprising in fluid communication from upstream to downstream, a bustle, a bustle chamber, and a combustion chamber. The bustle chamber has an oxidant diffusion device in fluid communication with the bustle. The system further includes a fuel inlet assembly constructed and arranged for insertion into at least one oxidant inlet port defined in the oxidant diffusion device.

In another aspect, the present invention provides a combustion system for producing a combustion gas in an axial tread carbon black reactor comprising in fluid communication from upstream to downstream, a bustle, a bustle chamber, and a combustion chamber. The bustle chamber has an oxidant diffusion device in fluid communication with the combustion chamber and the bustle. In this aspect, the system also includes a fuel inlet assembly constructed and arranged for insertion into the bustle chamber.

In another aspect, the present invention provides a method for producing a combustion gas in an axial tread carbon black reactor. The method comprises introducing an oxidant flow into a bustle chamber of an axial tread carbon black reactor. The bustle chamber comprises an oxidant diffusion device that divides the oxidant flow into at least one axial oxidant flow current and at least one radial oxidant flow current. Fuel is introduced into the bustle chamber of the axial tread carbon black reactor and the oxidant and the fuel are combusted to provide a combustion gas.

In still another aspect, the present invention provides a process for the production of carbon black in an axial flow tread carbon black reactor, comprising a) producing a combustion gas stream having an oxygen species concentration differential less than or equal to approximately 1.5 percent; b) reacting a carbon black yielding carbonaceous feedstock with the combustion gas stream of step a) to form a reaction stream containing carbon black; and quenching, cooling, separating and recovering the carbon black formed by the process of steps a) and b).

Additional advantages of the invention will be set forth in part in the description which follows, and in part will be obvious from the description, or may be learned by practice of the invention. Additional advantages of the invention, aside from those disclosed herein, will be realized and attained by means of the elements and combinations particularly pointed out in the appended claims. It is to be understood that both the foregoing general description and the following detailed description and figures are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a perspective view of an oxidant diffusion device according to one aspect of the present disclosure.

FIG. 2 is a cross-sectional side view of the oxidant diffusion device illustrated in FIG. 1.

FIG. 3 is an end view of the oxidant diffusion device illustrated in FIG. 1.

FIG. 4 is a perspective view of an oxidant diffusion device according to one aspect of the present disclosure.

FIG. 5 is a perspective view of an alternative embodiment of an oxidant diffusion device according to one aspect of the present disclosure.

FIG. 6 is a cross-sectional side view of the oxidant diffusion device illustrated in FIG. 5.

FIG. 7 is an illustration of a combustion system of the present invention comprising the oxidant diffusion device illustrated in FIGS. 1-3.

FIG. 8 is an illustration of a combustion system of the present invention comprising the oxidant diffusion device illustrated in FIGS. 5-6.

FIG. 9 is an illustration of a conventional 8 inch choke axial flow tread carbon black reactor.

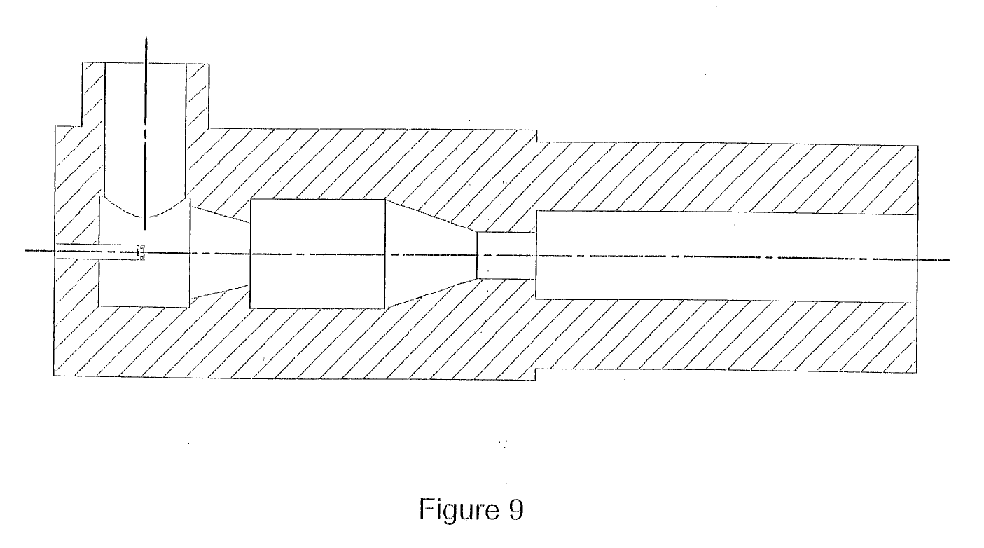

FIG. 10 is a plot of the oxygen species concentration measurements obtained in Examples 3 and 4.

FIG. 11 is a plot of the modeled oxygen species concentration measurements obtained in Examples 1 and 2.

FIG. 12 is a plot of the oxygen species concentration measurements obtained in Examples 7 and 8.

FIG. 13 is an illustration of the combustion zone of 8″ inch choke oil fired axial tread carbon black reactor utilized in Example 7.

### DETAILED DESCRIPTION OF THE INVENTION

The present invention may be understood more readily by reference to the following detailed description of preferred embodiments of the invention and the Examples included herein and to the Figures and their previous and following description.

Before the present compounds, compositions, articles, devices and/or methods are disclosed and described, it is to be understood that this invention is not limited to specific synthetic methods, specific embodiments, or to particular devices, as such may, of course, vary. It is also to be understood that the terminology used herein is for the purpose of describing particular embodiments only and is not intended to be limiting.

It must be noted that, as used in the specification and the appended claims, the singular forms “a,” “an” and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment.

In this specification and in the claims which follow, reference will be made to a number of terms which shall be defined to have the following meanings:

As used herein, the terms “optional” or “optionally” mean that the subsequently described event or circumstance may or may not occur, and that the description includes instances where said event or circumstance occurs and instances where it does not.

As used herein, by use of the term “effective,” “effective amount,” or “conditions effective to” it is meant that such amount or reaction condition is capable of performing the function of the compound or property for which an effective amount is expressed. As will be pointed out below, the exact amount required will vary from one embodiment to another, depending on recognized variables such as the compounds employed and the processing conditions observed. Thus, it is not always possible to specify an exact “effective amount” or “condition effective to.” However, it should be understood that an appropriate effective amount will be readily determined by one of ordinary skill in the art using only routine experimentation.

As used herein, a “typical” or “conventional” tread type reactor has separate combustion and reaction zones and produces carbon black products at flow velocities at the choke of about 300 to about 550 meters per second (m/s), temperatures of about 1500° C. to about 2100° C., and residence times of about 4 to about 200 milliseconds (ms). More specifically, a conventional tread reactor comprises, in open communication and in the following order from upstream to downstream a combustion zone, wherein the combustion zone comprises at least one inlet for introducing a combustion feedstock; a choke section, wherein the choke section comprises at least one inlet, separate from the combustion section inlet, for introducing a carbonaceous feedstock and wherein the choke section converges toward a downstream end, said downstream end having a minimum cross sectional area; a quench section, having a minimum cross sectional area, wherein the quench section comprises at least one inlet, separate from the combustion section and choke section inlets, for introducing a quench material; and a breeching section. Additionally, in a conventional tread reactor, the ratio of the quench section minimum cross sectional area to the choke section minimum cross sectional area is greater than or equal to 1.5.

As used herein, a conventional axial tread carbon black reactor combustion section comprises: (1) an oxidant introduction chamber, typically an overhead air pipe or duct, commonly called the bustle, (2) a bustle chamber, into which the bustle typically intersects perpendicularly, (3) a burner assembly, comprising a fuel pipe or spray nozzle that is inserted into the bustle chamber externally from the side or from the front face of the reactor; (4) a combustion choke which is a refractory diffusion ring at the end of the bustle chamber that serves to promote mixing of the fuel and oxidant; and (5) a combustion dwell section that is intended to allow residence time to complete the combustion process before the hot gases enter the choke section of the reaction zone where the carbonaceous feedstock is injected. Typical operational conditions for a conventional 8 inch choke axial tread reactor comprise an oxidant rate in the range of from about 5500 to about 8500 Nm³/hr; a fuel rate in the range of from approximately 350 to approximately 550 Nm³/hr; an optional oxygen enrichment rate in the range of from 0 to approximately 325 Nm³/hr; and an oxidant introduction temperature in the range of from approximately 450° C. to approximately 800° C.

As used herein, the term “maximum oxygen species concentration difference” or “oxygen species concentration gradient” refers to the difference between the highest concentration of oxygen species and the lowest concentration of oxygen species measured for a combustion gas in a given plane of a reactor. The concentration of oxygen species in the combustion gas is measured radially across a cylindrical cross section of the reactor at +45° and −45° from vertical, forming an “X” pattern across the plane of interest. Without limitation to the scope of the instant invention and for exemplary purposes only, the oxygen species concentration measurements described herein were measured across the plane of the reactor located at the point of entrance to the choke section of the reaction zone. Further, the measurements were obtained from r-values ranging from −8 inches to +8 inches across the diameter of the plane.

As described briefly above, in one aspect, the present invention provides an oxidant diffusion device for use in an axial tread carbon black reactor that is capable of improving one or more inefficiencies present in axial tread carbon black reactors of the prior art. More particularly, in one aspect, an oxidant diffusion device is provided that, when used with a conventional axial tread carbon black reactor, alters the conventional flow current of the oxidant and of the resulting combustion gases such that it produces a more uniform combustion environment. The more uniform combustion environment advantageously results in improved efficiency in converting the carbonaceous feedstock into carbon black product and produces higher yields of the desired high quality carbon black, i.e., a carbon black that exhibits desired characteristics such as primary particle size, aggregate size, structure, surface area, tint and the like.

Additionally, the oxidant diffusion devices of the present invention can be utilized in conventional axial tread reactors without introducing a significant pressure drop into the reactor system. When the total pressure drop across a carbon black reactor system exceeds the performance limits provided by the peripheral equipment, such as the blower system used for movement of the combustion oxidant, the flow velocity within the reactor can be significantly decreased resulting in a significant reduction in the potential production capacity of the reactor. To that end, the oxidant diffusion devices of the instant invention can be used in conventional reactors without introducing an increase in the pressure drop across the reactor greater than approximately 1.5 pounds per square inch, which is typically within the limits provided by a conventional axial tread carbon black reactor and the associated peripheral equipment. Therefore, the modification of a conventional reactor in order to utilize the oxidant diffusion devices of the instant invention does not require an upgrade or modification to peripheral equipment, such as the combustion oxidant blower.

It should also be noted that while the oxidant diffusion devices disclosed herein will be described in accordance with one or more preferred embodiments, these embodiments are not intended to be limiting but merely exemplary of additional embodiments and configurations that will become obvious to one of ordinary skill in the art upon practicing the invention. To that end, the oxidant diffusion device disclosed herein can be used in a wide variety of axial tread carbon black reactors and therefore for the production of a great range of carbon black products and is not limited to any one grade. For example, typical tread grade carbon blacks that can be produced using this oxidant diffusion device include, the N100 series carbon blacks through the N300 series carbon blacks and their variants, as measured by ASTM—D1765.

In one embodiment the present invention provides an oxidant diffusion device for use in either a brick or cast bustle chamber of a conventional axial tread carbon black reactor. In accordance with this embodiment, the oxidant diffusion device comprises a housing defining an internal cavity and having a distal end, an open proximal end, an exterior peripheral surface and a central longitudinal axis. The distal end has an upstream exterior face and an opposed downstream interior face. The exterior peripheral surface defines a plurality of first oxidant inlet ports positioned between the distal and proximal ends and in communication with the internal cavity. The distal end defines a plurality of second oxidant inlet ports extending between the exterior face and the interior face in communication with the internal cavity.

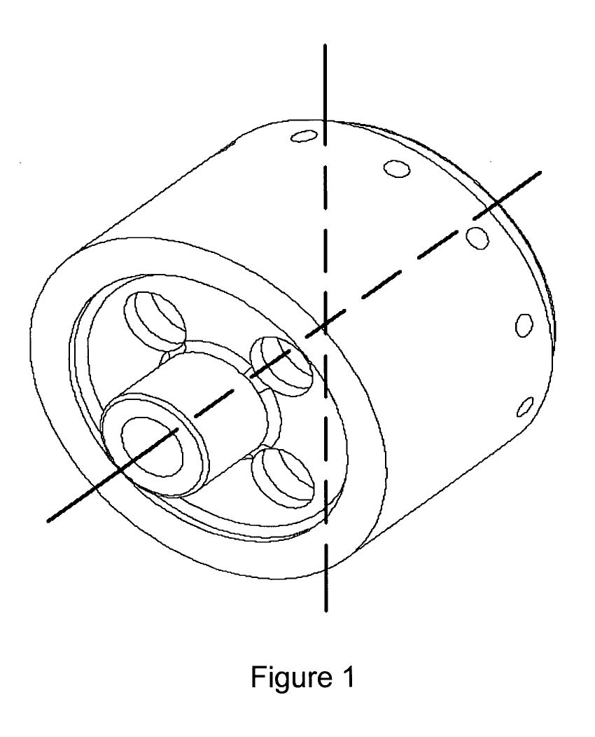

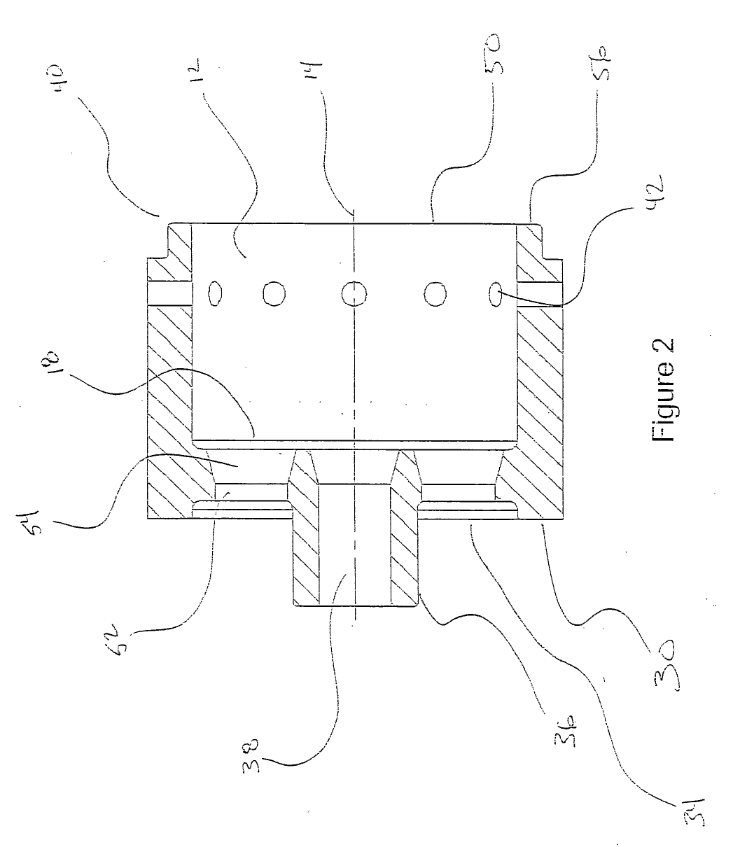

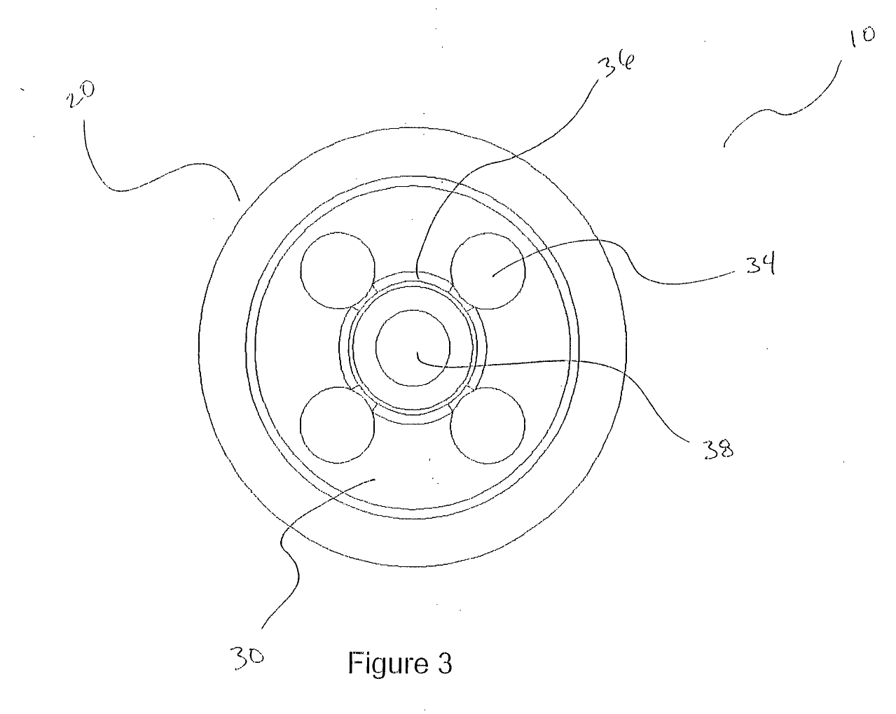

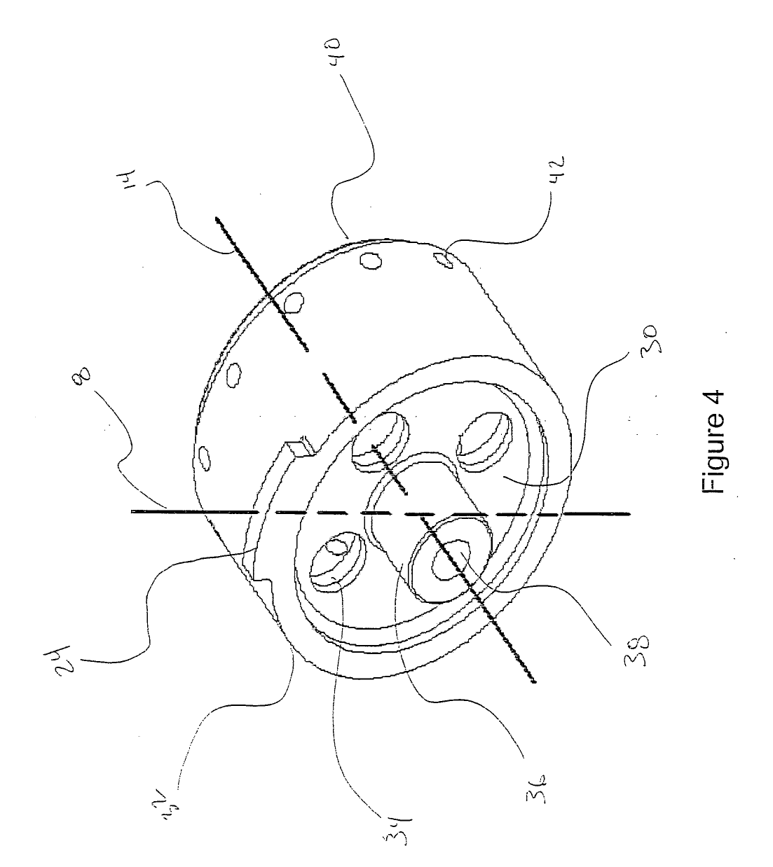

One exemplary configuration in accordance with this embodiment is illustrated in FIGS. 1-4. More specifically, FIG. 1 illustrates a perspective view of an oxidant diffusion device 10, which is comprised of a housing 20 that defines an internal cavity 12, as depicted in FIG. 2. The housing 20 has a distal end 30, an open proximal end 40, an exterior peripheral surface 22 and a central longitudinal axis 14. The distal end 30 has an upstream exterior face 16 and an opposed downstream interior face 18. The exterior peripheral surface 22 defines a plurality of first oxidant inlet ports 42 positioned between the distal and proximal ends and in communication with the internal cavity 12. The distal end 30 defines a plurality of second oxidant inlet ports 34 extending between the exterior face 16 and the interior face 18 in communication with the internal cavity. The downstream proximal end defines an outlet opening 50 in fluid communication with the internal cavity 12. In one aspect, the distal end 30 also comprises a peripherally circumferential flange 32 that extends, in cross-section, outwardly from the exterior face substantially parallel to the central longitudinal axis 14.

Further, the oxidant diffusion device can optionally comprise a male protrusion 36, that extends outwardly from the exterior face 16. The male protrusion defines a bore 38 that is an fluid communication with the internal cavity 12. The male protrusion may be substantially cylindrical. In one aspect, the cylindrical male protrusion 36 and bore 38 are centered about the central longitudinal axis of the housing. In another aspect, the peripheral housing surface 22 has an arcuate flange 24 extending outwardly away from the exterior peripheral surface substantially transverse to the central longitudinal axis of the housing. In one aspect, the arcuate flange 24 extends partially about the peripheral surface of the housing and is positioned proximate the distal end of the housing. In another aspect, the housing has a substantially upright axis and a portion of the arcuate flange 24 is positioned in a plane extending through the upright axis and the central longitudinal axis of the housing.

It is contemplated by the invention and as will be appreciated by one of ordinary skill in the art, that the plurality of first oxidant inlet ports 42 can include any number of ports without limitation. In various aspects, the first oxidant inlet ports may number 2 ports to 24 ports. Additionally, in alternative aspects, the oxidant diffusion device can comprise 3, 4, 5, 6, 7, 8, 9, 10, 11, 12, 13, 14, 15, 16, 17, 18, 19, 20, 21, 22, or even 23 first oxidant inlet ports.

The plurality of first oxidant inlet ports 42 can also be configured of any desired size and shape. To that end, in one aspect the plurality of first oxidant inlet ports 42 are substantially circular in shape. In another aspect, the plurality of first oxidant inlet ports 42 each have a substantially equal cross-sectional area. In still another aspect, one or more of the plurality of first oxidant inlet ports 42 can be of a different size and or shape than the remaining plurality of first oxidant inlet ports.

Accordingly, as depicted in FIGS. 1-4, the plurality of first oxidant inlet ports 42, are in one aspect, circumferentially spaced about the periphery of the housing member 20, and positioned at a predetermined position between the distal and proximal ends. In one aspect, the plurality of first oxidant inlet ports are substantially uniformly spaced about the exterior peripheral surface. It will be appreciated that in accordance with this aspect, the degree of separation between the each of the plurality of first oxidant inlet ports 42 will depend on the number of first oxidant inlet ports 42 present in the oxidant diffusion device. For example, in an embodiment having twelve first oxidant inlet ports 42, the degree of separation will be approximately 30 degrees. In an embodiment having twenty four first oxidant inlet ports 42, the degree of separation will be 15 degrees.

It is further contemplated by the invention that the plurality of first oxidant inlet ports 42 can be positioned at any predetermined location between the distal and proximal ends. For example, in one aspect, the plurality of first oxidant inlet ports 42 can each be individually positioned at a different location between the proximal and distal ends. In another example, more than one of the plurality of first oxidant inlet ports 42 can be positioned at an equal location between the distal and proximal ends. In one aspect, the plurality of first oxidant inlet ports is positioned in a plane that is substantially transverse to the central longitudinal axis of the housing. Further, each first oxidant port of the plurality of first oxidant inlet ports 42 can be formed such that it extends generally in a plane transverse to the longitudinal axis of the housing.

The plurality of second oxidant inlet ports 34 can also include any number of ports without limitation. In various aspects, the second oxidant inlet ports can number from 2 second oxidant inlet ports to 8 second oxidant inlet ports. Additionally, in alternative aspects, the oxidant diffusion device can comprise 3, 4, 5, 6, or 7 second oxidant inlet ports.

The plurality of second oxidant inlet ports 34 can also be configured of any desired size and shape. To that end, in one aspect the second oxidant inlet ports 34 are substantially circular in shape. In another aspect, the second oxidant inlet ports 34 are generally rectangular in shape. In still another aspect, the plurality of second oxidant inlet ports 34 can each have an at least substantially equal cross-sectional area. Alternatively, one or more of the plurality of second oxidant inlet ports 34 can be of a different size and/or shape than the remaining plurality of second oxidant inlet ports.

In one aspect, the plurality of second oxidant inlet ports 34 can taper outwardly downstream from the exterior face toward the interior face. For example, and as depicted in FIG. 2, the plurality of second oxidant inlet ports 34 can have a first portion 52 proximate to the exterior face and having a first cross-sectional area; and a second portion 54 proximate to the interior face having a second cross sectional area, wherein the first cross-sectional area is less than the second cross sectional area. Here, the second portion of the second oxidant inlet port can taper outwardly away from the end of the first portion of the second oxidant inlet port. In one aspect, second oxidant inlet ports 34 are substantially circular in shape, wherein the first portion proximate to the exterior distal end face has approximately a 4 inch inlet diameter and wherein the second portion proximate to the interior face has approximately a 5 inch outlet diameter.

As depicted in FIGS. 1-4, the plurality of second oxidant inlet ports 34, are in one aspect, spaced at substantially the same radial distance from the central longitudinal axis of the housing. As shown, the second oxidant inlet ports, in one aspect, can be spaced substantially equally apart from each other. It will be appreciated that in accordance with this aspect, the degree of separation between each of the plurality of second oxidant inlet ports 34 will depend on the number of ports 34 present in the oxidant diffusion device. For example, in an embodiment having 4 second oxidant inlet ports 34, the degree of separation will be approximately 90 degrees. In an embodiment having 8, second oxidant inlet ports 34, the degree of separation will be approximately 45 degrees. In another aspect, the plurality of second oxidant inlet ports is positioned therebetween the peripheral circumferential flange and the male protrusion.

While the oxidant diffusion devices described herein can be sized and shaped in any desired manner, with specific reference to a particular embodiment, the distal end 30 of the housing 20 has an outside diameter of approximately 58.4 cm and an inside diameter of approximately 45.7 cm, thus providing an approximate cylindrical wall thickness of about 6.35 cm. The housing 20 in this aspect is also approximately 43.2 cm in length, as measured from the peripheral flange 32 to the downstream proximal end 40.

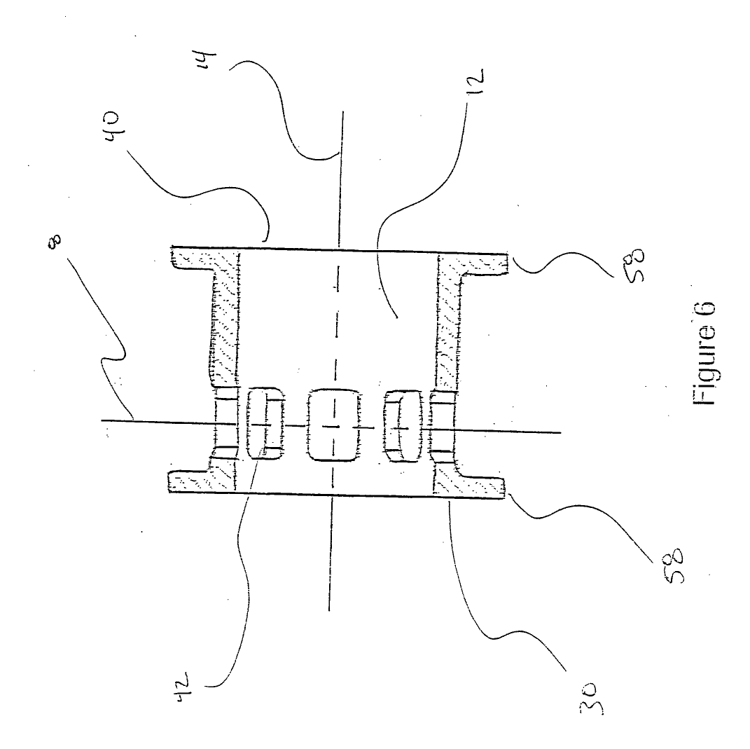

In another aspect, the downstream proximal end 40 of the housing 20 has an outside diameter of approximately 52.7 cm and inside diameter of approximately 45.7 cm. In still another aspect, and as depicted in FIG. 2, the outside diameter of the downstream end is smaller than that of the upstream end such that a lip 56 is provided for mating the downstream proximal end 40 of the oxidant diffusion device 10 with a combustion choke section of an axial tread carbon black reactor, as depicted in FIG. 6. In accordance with this aspect, the lip 56 extends for a distance of approximately 5.1 cm upstream from the downstream proximal end 40 of the housing 20.

The distance between the exterior distal end face 16 and the interior distal end face 18 in one aspect is approximately 7.62 cm thick. In one aspect, the exterior distal end face 16 is recessed downstream approximately 2.54 cm from the upstream end of the peripherally extending flange 32. In this aspect, the distal end 30 defines four second oxidant inlet ports 34, circumferentially spaced approximately 90 degrees apart on an approximately 29.2 cm diameter ring centered about the central longitudinal axis of the housing 20. It should be appreciated that the diameter ring about the central axis, the sizing of the inlet apertures, and the degree of circumferential spacing will ultimately depend on the number of inlet apertures desired, as such may of course vary.

The axial sight port bore 38, defined by the male protrusion 36, is in one aspect 10.15 cm in diameter. In this aspect, male protrusion 38 also extends approximately 15.25 cm upstream from the exterior face 16 of the distal end 30 and has a thickness of approximately 7.62 cm.

In another aspect, the plurality of first oxidant inlet ports 42 comprises twelve first oxidant inlet ports each having a diameter of approximately 3.5 cm and each being circumferentially spaced approximately 30 degrees apart about the circumference of the cylindrical housing and positioned approximately 4 inches from the downstream end 40 of the cylindrical housing. Once again, it should be appreciated that the number of first oxidant inlet ports 42, the sizing of the first oxidant inlet ports, their predetermined distance from the downstream proximal end of the housing member and the degree of circumferential spacing will ultimately depend on the number of first oxidant inlet ports desired and the overall size of the oxidant diffusion device to be used, as such may of course vary.

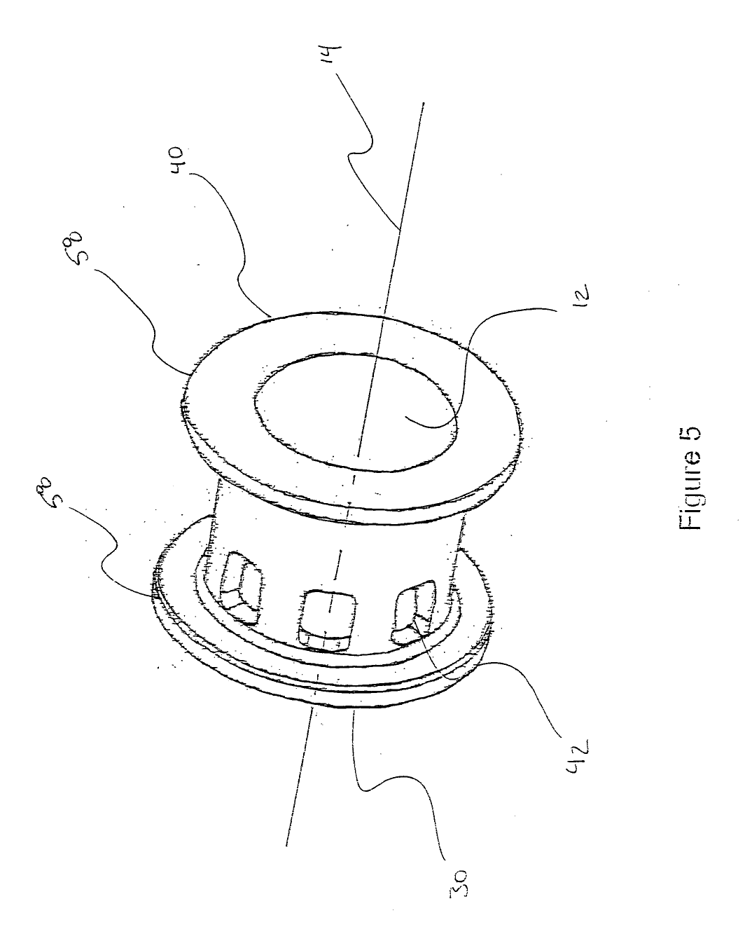

In another embodiment, the present invention provides an oxidant diffusion device for use in either a brick or cast bustle chamber of a conventional axial tread carbon black reactor, the device having a housing member defining an internal cavity and having a distal end, an open proximal end, an exterior peripheral surface and a longitudinal axis. In this aspect, the exterior peripheral surface defines a plurality of oxidant inlet ports positioned between the distal and proximal ends and in communication with the internal cavity. One configuration in accordance with this embodiment is illustrated in appended FIGS. 5 and 6.

In this aspect, an oxidant diffusion device 10 comprises of a cylindrical housing member 20. The cylindrical housing further defines an internal cavity 12 and has an upstream distal end 30, a downstream open proximal end 40 having an opening 50 in fluid communication with the internal cavity 12, an exterior peripheral surface 22 and a longitudinal axis 14. The distal and proximal ends optionally comprise peripherally extending flange members 58, wherein the flange members 58 extend outwardly from the exterior peripheral surface of the housing in a plane substantially transverse to the longitudinal axis 14.

As further depicted in FIGS. 5 and 6, the exterior peripheral surface of the housing member 20 further defines a plurality of first oxidant inlet ports 42 that are in fluid communication with the internal cavity of the housing member. The oxidant inlet ports are spaced about the exterior peripheral surface of the housing members and are positioned in a plane substantially transverse to the longitudinal axis of the housing member. In one aspect, the oxidant inlet ports are spaced substantially equally apart, circumferentially around the longitudinal axis 14 of the cylindrical housing. Once again, it should be appreciated that the number of first oxidant inlet ports 42, the sizing and shape of the oxidant inlet ports, their predetermined distance from the downstream end of the cylindrical housing and the degree of circumferential spacing will ultimately depend on the number of inlet ports desired and the overall size of the oxidant diffusion device to be used, as such may of course vary.

To that end, in accordance with this aspect, the oxidant diffusion device exemplified in FIGS. 5 and 6 can have any desired number of first oxidant inlet ports, including without limitation, from 2 to 24 oxidant inlet ports. It is further contemplated in alternative aspects that the oxidant diffusion device can comprise 3, 4, 5, 6, 7, 8, 9, 10, 11, 12, 13, 14, 15, 16, 17, 18, 19, 20, 21, 22, or even 23 oxidant inlet ports 42.

The plurality of first oxidant inlet ports 42 can also be configured of any desired size and shape. To that end, in one aspect the ports 42 are substantially circular in shape. In another aspect, the plurality of oxidant ports 42 are generally rectangular. In this aspect, it is contemplated that each corner of the generally rectangularly shaped inlet port can have a curved radius.

In still another aspect, the plurality of ports 42 each have a substantially equal cross-sectional area. In still another aspect, one or more of the plurality of ports 42 can be of a different size and or shape than the remaining plurality of first oxidant inlet ports. In another aspect, the housing member has a substantially upright axis and a portion of a first oxidant port of the plurality of oxidant inlet ports is positioned in a plane that extends through the upright axis and the longitudinal axis of the housing. In this aspect, the first oxidant port has a cross-sectional area that is less than the cross-sectional area of the remaining oxidant ports.

Accordingly, as depicted in FIGS. 5-6, the plurality of first oxidant inlet ports 42, are, in one aspect, circumferentially spaced in an equidistant relationship about the periphery of the housing member 20, and positioned at a predetermined position between the distal and proximal ends. It will be appreciated that in accordance with this aspect, the degree of separation between the each of the plurality of oxidant inlet ports 42 will depend on the number of ports 42 present in the oxidant diffusion device. For example, in an embodiment having 8 oxidant inlet ports 42, the degree of separation will be approximately 45 degrees. In an embodiment having 12 oxidant inlet ports 42, the degree of separation will be approximately 30 degrees.

It is further contemplated by the invention that the plurality of first oxidant inlet ports 42 can be positioned at any predetermined location between the distal and proximal ends. For example, in one aspect, the plurality of oxidant inlet ports 42 can each be individually positioned at a different location between the proximal and distal ends. In another example, more than one of the plurality of oxidant inlet ports 42 can be positioned at an equal location between the distal and proximal ends. In still another example, each oxidant inlet port 42 can be formed such that they extend generally in a plane transverse to the longitudinal axis of the housing member.

It should be understood that the oxidant diffusion devices of the instant invention can be manufactured from any material that is suitable for use in the combustion section of an axial tread carbon black reactor. Non-limiting examples include metal, stainless steel, ceramics and other castable materials. In one aspect, the oxidant diffusion device is manufactured from HPCast 93Z3, a castable ceramic material available from Harbison-Walker Refractories, Moon Township, Pa.

Further, it should be appreciated that the oxidant diffusion devices of the instant invention can comprise a housing or housing member of any shape and/or size that is suitable for use in the combustion zone of an axial tread carbon black reactor provided that the oxidant diffusion device is capable of providing the desired uniformity of the combustion gas. In one aspect, the housing member is cylindrical thereby defining a cylindrical interior cavity. In alternative aspects, the housing member can be a cup shaped member, elliptical, square, rectangular, pentagonal, hexagonal, heptagonal, octagonal and the like.

In another aspect, the present invention provides a combustion system for producing a combustion gas in an axial tread carbon black reactor comprising, in fluid communication from upstream to downstream, a bustle, a bustle chamber, and a combustion chamber. The bustle chamber further comprises an oxidant diffusion device comprising a housing having a central longitudinal axis and defining an internal cavity, comprising an open proximal end, an opposed distal end having an exterior face and an opposed interior face, and an exterior peripheral surface extending substantially between the proximal and distal ends of the housing. The exterior peripheral surface of the housing defines a plurality of first oxidant inlet ports, the plurality of first oxidant inlet ports in fluid communication with the internal cavity of the housing and the bustle. The distal end of the housing defines a plurality of second oxidant inlet ports extending from the exterior face to the interior face of the distal end, the plurality of second oxidant inlet ports in fluid communication with the internal cavity of the housing and the bustle. The proximal end of the housing is in fluid communication with the combustion chamber. In accordance with this aspect, the combustion system also comprises a fuel inlet assembly constructed and arranged for insertion into at least one second oxidant inlet port of the plurality of second oxidant inlet ports.

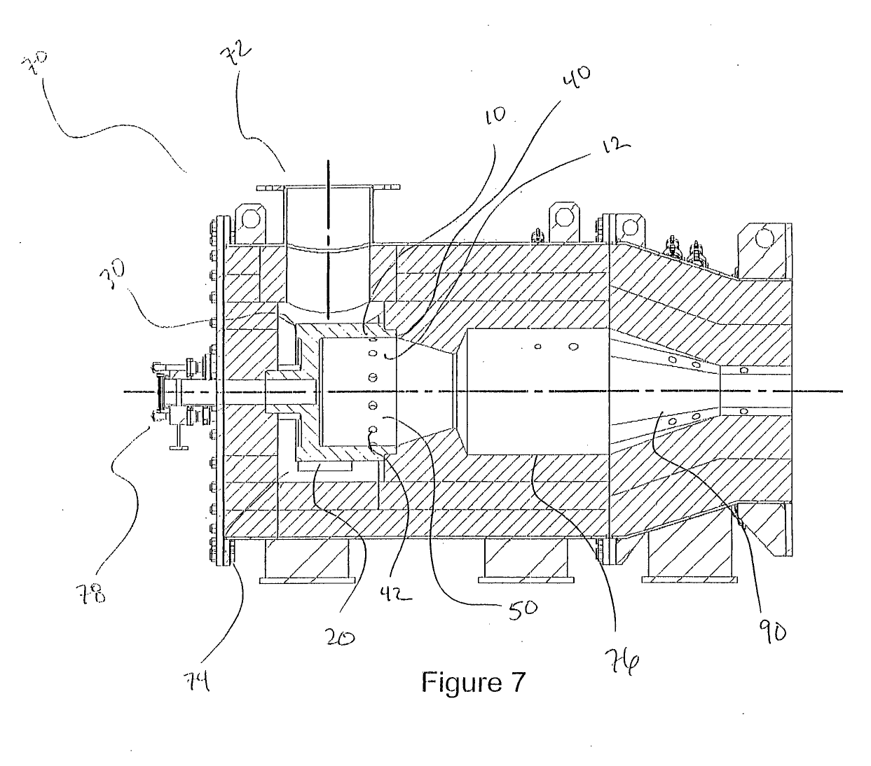

To this end, FIG. 7 depicts one arrangement of a combustion system in accordance with the present invention. Specifically, FIG. 7 depicts an axial flow tread carbon black reactor combustion system 70. The combustion system comprises a bustle 72, a bustle chamber 74, and a combustion chamber 76. The bustle chamber further comprises a plurality of fuel introduction ports 78, and an oxidant diffusion device 10 as disclosed herein.

In one aspect, the oxidant diffusion device 10, comprises a housing member 20 defining an internal cavity 12 and defining a plurality of first oxidant inlet ports 42. The first oxidant inlet ports provide a path of fluid communication between the internal cavity and the bustle. The housing member further comprises an upstream distal end 30 and a downstream proximal end 40. The distal end having an upstream exterior face 16 and a downstream interior face 18 and further defining a plurality of second oxidant inlet ports 34, wherein the second oxidant inlet ports provide a path of fluid communication between the internal cavity 12 and the bustle 72. The proximal housing end 40 defines an opening 50 providing a path of fluid communication between the internal cavity and the combustion chamber 76.

The plurality of fuel introduction ports 78 are aligned coaxially with the plurality of axial oxidant inlet apertures 34 and project downstream toward the second oxidant inlet ports.

An initial oxidant flow current, typically comprised of heated air, enters the top of the bustle chamber 74 through the bustle 72. The oxidant diffusion device 10 then divides the initial oxidant flow current between the plurality of axial and radial oxidant inlet apertures 34 and 42 respectively. In one aspect, when modeled by computational fluid dynamics, the ratio of the sum of the flow volumes of the axial oxidant flow currents to the sum of the flow volumes of the radial oxidant flow currents is in the range of from approximately 3:2 to approximately 4:1. In another aspect, the ratio of the sum of the flow volumes of the axial oxidant flow currents to the sum of the flow volumes of the radial oxidant flow currents is approximately 3:1.

Exemplified fuel introduction ports 78, consisting of approximately 0.75 inch capped piping with approximately eight 5/32 inch apertures, extend through the front face of the reactor and are centered in alignment with the axial inlet apertures 34 of the oxidant diffusion device 10. The axial inlet apertures generally align the resulting combustion mixture of air and fuel axially within the oxidant diffusion device. As the air flow through the radial inlet apertures impinges the aligned air/fuel combustion mixture within the oxidant diffusion device, a plurality of recirculation zones are created that rapidly decrease thermal gradients in the flow of combustion gas prior to its entry into the downstream choke section 90 and subsequent reaction with the carbonaceous feedstock.

In another embodiment, the present invention provides a combustion system for producing a combustion gas in an axial tread carbon black reactor comprising in fluid communication from upstream to downstream, a bustle, a bustle chamber, and a combustion chamber comprising an oxidant diffusion device comprising: a housing member having a longitudinal axis and defining an internal cavity, the housing member having a distal end, an opposed open proximal end, and an exterior peripheral surface that defines a plurality of oxidant inlet ports positioned between the distal and proximal ends of the housing member. Each oxidant inlet port of the plurality of oxidant inlet ports is in fluid communication with the internal cavity of the housing member and the bustle. The plurality of oxidant inlet ports are spaced apart about the exterior peripheral surface of the housing member and are positioned in a plane substantially transverse to the longitudinal axis of the housing member. The proximal end of the housing member is in fluid communication with the combustion chamber. The combustion system further comprises a fuel inlet assembly constructed and arranged for insertion into the combustion choke. Alternatively, the fuel inlet assembly can be constructed and arranged for insertion into the bustle chamber and/or the internal cavity of the oxidant diffusion device.

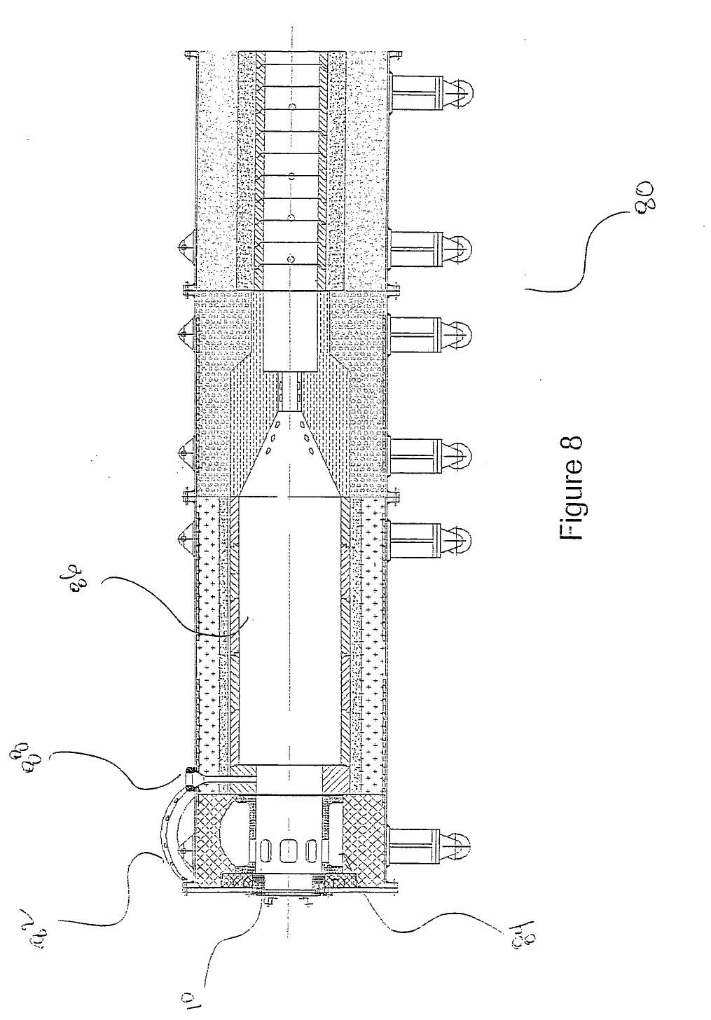

To that end, FIG. 8 depicts one arrangement of a combustion system in accordance with this aspect the present invention. Specifically, FIG. 8 depicts an axial flow tread carbon black reactor combustion system 80. The combustion system comprises a bustle 82, a bustle chamber 84, and a combustion chamber 86. The bustle chamber further comprises a plurality of fuel introduction ports 88, and an oxidant diffusion device 10 as disclosed herein.

In one aspect, the oxidant diffusion device 10 is a device as depicted in FIGS. 5 and 6 comprising a housing member 20 defining an internal cavity 12 and defining a plurality of first oxidant inlet ports 42. The plurality of first oxidant inlet ports provide a path of fluid communication between the internal cavity and the bustle. The housing member further comprises an upstream distal end 30 and a downstream proximal end 40. The proximal housing end 40 defines an opening 50 providing a path of fluid communication between the internal cavity and the combustion chamber 86.

The plurality of fuel introduction ports 88 project into the bustle chamber in a radial arrangement downstream from the proximal end of the oxidant diffusion device. In one aspect, there are three fuel introduction ports with each port radially spaced about 120 degrees apart. In an alternative aspect, there are four fuel introduction ports with each port radially spaced about 90 degrees apart.

During operation, an initial oxidant flow current, typically comprised of heated air, enters the top of the bustle chamber 84 through the bustle 82. The oxidant diffusion device 10 then divides the initial oxidant flow current among the plurality radial oxidant inlet apertures 42. The plurality of oxidant flow patterns increases the turbulence within the oxidant flow and can therefore provide a more uniform combustion environment.

It should be appreciated that depending on the desired oxidant diffusion device configuration and the particular conventional carbon black reactor in which the oxidant diffusion device will be used, it may be necessary to modify the combustion zone of the reactor in one or more ways in order to properly retrofit the reactor to receive the oxidant diffusion device. For example, the bustle chamber may need to be enlarged depending on the outside diameter of the oxidant diffusion device cylindrical housing. Likewise, the upstream end of the combustion choke can be modified to mate with the downstream end of the oxidant diffusion device. Additionally, the front face of the reactor's combustion chamber can be modified to accept the circular flange and axial sight port. The need for any modifications and the nature of said modifications will be obvious to one of skill in the art upon reading this disclosure and/or practicing the features as claimed and can be successfully determined through routine experimentation.

At this point, it should also be understood that the embodiments illustrated by the appended figures are only representative configurations of possible embodiments of the oxidant diffusion devices and combustion systems comprising same. Therefore, it is not intended for the appended figures to limit the scope of this disclosure in any way. Moreover, the particular embodiments depicted are configured for use in a conventional 8 inch choke design axial tread carbon black reactor. Accordingly, one of skill in the art will appreciate that the specific dimensions and configurations described herein are not limiting, as such may of course vary, depending on the actual axial tread carbon black reactor to be used.

In another aspect, disclosed is an axial tread carbon black reactor comprising an oxidant diffusion device as described herein. The carbon black reactor comprises two zones, a combustion zone and a reaction zone. The combustion zone further comprises, in fluid communication from upstream to downstream, a bustle, a bustle chamber, a combustion choke, and a combustion chamber, wherein the bustle chamber further comprises an oxidant diffusion device according to the present disclosure.

In still another aspect, the present disclosure provides a method for producing a combustion gas in an axial tread carbon black reactor. In one embodiment, the method comprises introducing an initial oxidant flow into a bustle chamber of an axial tread carbon black reactor, dividing the initial oxidant flow into a plurality of oxidant flow currents; introducing a fuel into the bustle chamber of the axial tread carbon black reactor; and combusting the oxidant and the fuel to provide a combustion gas.

To this end, in one embodiment the method comprises introducing the oxidant into a bustle chamber that comprises an oxidant diffusion device as disclosed herein. In one aspect, the oxidant diffusion device comprises a housing member defining an internal cavity and having a distal end and a proximal end, an opening defined by the proximal housing end and in fluid communication with the internal cavity, a plurality of radial oxidant inlet apertures defined by the housing and in fluid communication with the internal cavity, and a plurality of axial oxidant inlet apertures defined by the distal housing end and in fluid communication with the internal cavity. Accordingly, the oxidant diffusion device divides the initial oxidant flow current into at least one axial oxidant flow current and at least one radial oxidant flow current within the bustle chamber.

In one aspect, when modeled by computational fluid dynamics, the method provides at least one axial oxidant flow current and at least one radial oxidant flow current wherein the ratio of the sum of the flow volumes of the axial oxidant flow currents to the sum of the flow volumes of the radial oxidant flow currents is in the range of from approximately 3:2 to approximately 4:1. In another aspect, the ratio of the sum of the flow volumes of the axial oxidant flow currents to the sum of the flow volumes of the radial oxidant flow currents is approximately 3:1.

In another aspect, the method comprises introducing a fuel into the oxidant diffusion device through a plurality of fuel introduction ports coaxially aligned with the axial oxidant inlet apertures and in fluid communication with the internal cavity of the oxidant diffusion device. It should be understood that any desired number of fuel introduction ports can be used, including without limitation, 2, 3, 4, 5, 6, 7, or even 8. To that end, in one aspect the number of fuel introduction ports is equal to the number of axial oxidant introduction ports. Therefore, if a particular embodiment is configured to include four axial oxidant introduction ports, in one aspect that embodiment will also comprise four fuel introduction ports.

The fuel and the plurality of oxidant flow currents are then combusted to provide a combustion gas. The axial inlet apertures advantageously align the resulting combustion mixture of oxidant and fuel axially within the oxidant diffusion device. As the remaining oxidant flows through the radial inlet apertures, it impinges the aligned oxidant/fuel gas combustion mixture within the oxidant diffusion device to create a plurality of recirculation zones that rapidly decrease thermal gradients in the flow of combustion gas prior to its entry into a downstream choke section and subsequent reaction with a carbonaceous feedstock.

The ability of the oxidant diffusion devices, combustion systems and methods set forth herein to provide a more uniform combustion environment relative to the combustion environment in a conventional axial tread carbon black reactor can be determined by profiling the chemical properties of the combustion gases present within the carbon black reactor. More specifically, and as detailed in the following Examples, the oxidant diffusion device of the instant invention advantageously provides a combustion gas comprising a maximum oxygen concentration difference that does not exceed approximately 1.5% when measured at the entrance to the reaction zone of the reactor. In contrast, a conventional axial tread carbon black reactor typically provides a combustion gas comprising a maximum oxygen species concentration difference of at least approximately 3%. Therefore, the reduction in the maximum oxygen species concentration difference is indicative of a more complete and uniform combustion of the oxidant present in the combustion zone of the reactor. Additionally, it will be appreciated by one of ordinary skill in the art that the reduced maximum difference in oxygen species concentration corresponds to a more uniform temperature within the reactor for a given oxidant to fuel ratio. This uniformity, reduces the likelihood of “hot spots” within the reactor and can therefore provide the ability to operate the reactor at a reduced oxidant to fuel ratio and thus increase the flame temperature in the reactor accordingly.

By improving the air and fuel distributions and the subsequent mixing thereof, the combustion environment in the combustors becomes more homogenous and therefore approaches more ideal conditions. This means that the temperature and species concentrations downstream from the flames are closer to their expected theoretical values as determined by known scientific principles for a given set of operating conditions. As one of ordinary skill in the art will appreciate, large gradients in temperature and species concentrations produced within a combustion environment indicate a poor air and fuel distribution and mixing. To that end, it can be shown that the local oxygen concentration is inversely proportional to the local temperature at any observed point. For axial tread carbon black reactor combustion systems described herein, it has been found that approximately a 1% difference in oxygen concentration, across a measurement plane, correlates to a thermal gradient of about 56° C. Accordingly, the mean temperature will approach the theoretical maximum temperature at a given plane when the maximum oxygen species concentration differences are reduced. These gradients can effect the carbon black synthesis reactions where feedstock oil is injected, as it is well known to those of ordinary skill in the art that increases in the temperature of the combustion gases can provide an overall increase in carbon black yield and even an increase in the maximum production rate for a given reactor.

To that end, and as more particularly detailed in the appended Examples, the oxidant diffusion device of the instant invention, when used in a conventional axial tread carbon black reactor, can increase the yield of carbon black product produced for a given oxidant to fuel ratio and rate of carbonaceous feedstock injection. Accordingly, in one aspect, the yield is increased in the range of from approximately 2% to approximately 4% relative to the yields produced in the conventional axial tread carbon black reactor in the absence of the oxidant diffusion device. It is also contemplated and as will become apparent to one of ordinary skill in the art, additional yield increase can be obtained by the incremental reduction of oxidant to fuel ratio made possible by the more uniform combustion temperature profiles within the reactor.

In still another aspect, the instant disclosure provides a method for the manufacture of carbon black. More particularly, the method comprises the steps of combusting an oxidant and a fuel in a combustor section of an axial tread carbon black reactor under conditions effective to provide at least one combustion gas having a maximum oxygen species concentration difference less than or equal to 1.5 volume %, injecting a carbonaceous feedstock into a choke section of the carbon black reactor, and reacting the carbonaceous feedstock with the at least one combustion gas in the tread reactor to provide a carbon black.

### Experimental

The following examples and experimental data are put forth so as to provide those of ordinary skill in the art with a complete disclosure and description of how the oxidant diffusion devices disclosed and claimed herein are made, used and/or evaluated, and are intended to be purely exemplary of the invention and are not intended to limit the scope of what the inventors regard as their invention. Efforts have been made to ensure accuracy with respect to numbers (e.g., amounts, temperature, etc.) But some errors and deviations should be accounted for. Unless indicated otherwise, parts are parts by weight, temperature is in ° C. or is at ambient temperature, and pressure is at or near atmospheric.

As referred to in the following examples, the oxygen species concentration of a combustion gas within an axial tread carbon black reactor was measured using a species aspiration probe custom made by Air Liquide (Houston, Tex.) and made of stainless steel tubing, having 3 concentric tubes. The outer tube was approximately 19 mm in outside diameter, while the inner tube was approximately 32 mm to 48 mm inch in inside diameter. The intermediate tube was sized appropriately to allow water to enter the probe from one port into the annulus between it and the inner tube from one end, flow down the length, turn at the end cap and flow back between the annulus and the outer tube, where the water exited from the other port. The inserted end of the probe is capped or sealed between the concentric outer and inner tubes, and the external end has 3 ports, a water inlet, a water outlet, and the aspirated gas outlet, which is the inner diameter of the inner tube. The probe was sized accordingly to take measurements across the cross section of the conventional 8 inch choke axial flow tread carbon black reactor from an oil port position in the choke section of the reactor. The approximate length of the probe was 63 inches. The cooling water was common tap water adjusted to a flow rate that was not measured but was suitable to ensure the temperature of the probe remained reasonable to the human touch.

As referred to in the following examples, the combustion gas analyzer was a hand-held Testo 325-M CGA (obtained from Testo, Inc., Flanders, N.J.). The analyzer measured the oxygen species concentration by pumping the aspirated combustion gas through detection cells and was calibrated for use with a natural gas combustion environment. The aspirated combustion gas was conveyed to the gas analyzer using ¼ inch OD FEP plastic tubing, (obtained from Cole-Parmer, Vernon Hills, Ill.) Swagelok fittings, and a condensed-water drop-out vessel from United Filtration Systems, Sterling Heights, Mich.

### EXAMPLE 1

### Computational Fluid Dynamic (CFD) Modeling of a Conventional 8 Inch Choke Axial Flow Tread Carbon Black Reactor Combustion Gas Profile

The production of a combustion gas in a combustion zone of a conventional 8 inch choke axial flow tread carbon black reactor, such as that disclosed in U.S. Pat. Nos. 4,927,607 and 5,256,388 and depicted in FIG. 8, was modeled using computational fluid dynamics software installed on a Hewlett Packard J6700 workstation cluster. The CFD software was Fluent, available from Fluent, Inc. (Centerra Resource Park, 10 Cavendish Court, Lebanon, N.H.). The modeled reactor contained one fuel gas gun inserted from the front of the reactor to a position where the tip of the fuel gas gun was approximately under the center line of the 14 inch bustle inlet. The combustion zone was then modeled under the following operating conditions set forth below in Table 1:

TABLE 1

| | |
|---|---|
| Blast Air Rate, Nm³/hr | 8015 |
| Blast Air Temperature, C. | 566 |
| Natural Gas Rate, Nm³/hr | 553 |
| Blast Ratio | 14.5 |
| Oxygen enrichment Nm³/hr | 316 |

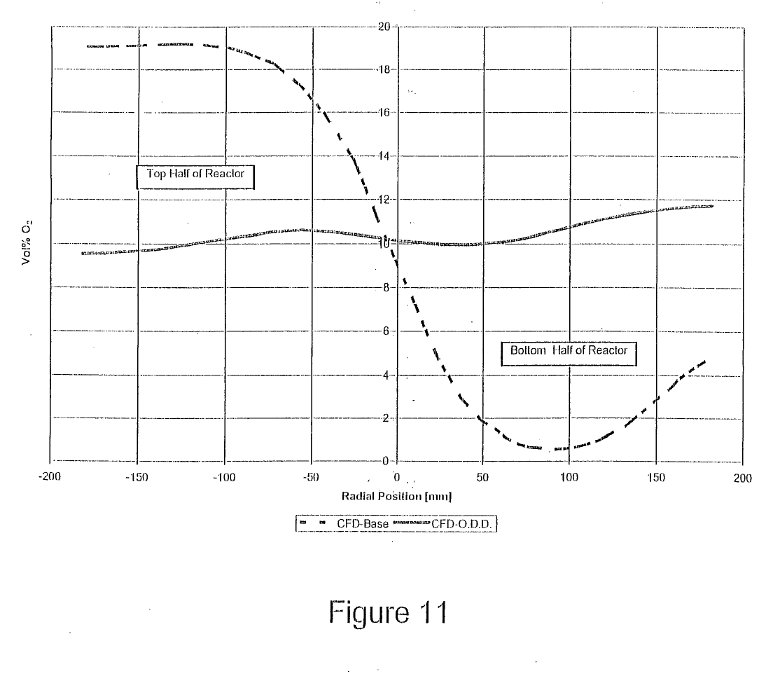

The uniformity of the modeled combustion gas environment was analyzed using the Fluent software. More specifically, the modeled concentration of oxygen in the combustion gas was analyzed at the entrance to the modeled reactor's choke section. The modeled concentration of oxygen species is charted in FIG. 11 and is represented by the graph labeled “C.F.D. Base”. As depicted therein, the plot indicates that the maximum oxygen concentration difference in the modeled combustion gas produced in a conventional reactor was approximately 19.0% with a mean concentration of approximately 11.7%.

### EXAMPLE 2

### Computational Fluid Dynamic (CFD) Modeling of an 8 Inch Choke Axial Flow Tread Carbon Black Reactor Containing the Oxidant Diffusion Device Depicted in FIGS. 1 through 3

The production of a combustion gas in a combustion zone of a conventional 8 inch choke axial flow tread carbon black reactor, modified by the insertion of an oxidant diffusion device as depicted in FIGS. 1-3, was modeled using computational fluid dynamics software installed on a Hewlett Packard J6700 workstation cluster. The CFD software was Fluent, available from Fluent, Inc. The modeled reactor also contained four fuel introduction ports coaxially aligned with the four second axial oxidant inlet ports of the oxidant diffusion device and inserted from the front of the reactor to a position where the tip of the fuel gas gun was proximate to the exterior face of the oxidant diffusion device. The combustion zone was then modeled under the following operating conditions set forth below in Table 2:

TABLE 2

| | |
|---|---|
| Blast Air Rate, Nm³/hr | 8015 |
| Blast Air Temperature, C. | 566 |
| Natural Gas Rate, Nm³/hr | 553 |
| Blast Ratio | 14.5 |
| Oxygen enrichment Nm³/hr | 316 |

The uniformity of the modeled combustion gas environment was analyzed using the Fluent software. More specifically, the modeled concentration of oxygen in the combustion gas was analyzed at the entrance to the modeled reactor's choke section. The modeled concentration of oxygen species is charted in FIG. 11 and is represented by the C.F.D.-O.D.D. graph. As depicted therein, the plot indicates that the maximum oxygen concentration difference in the modeled combustion gas produced in a conventional reactor was approximately 2.9% with a mean concentration of approximately 10.7%.

Actual in-reactor analysis of oxygen gas species was then conducted to confirm the modeling results obtained by the computation fluid dynamic modeling experiments set forth above. The oxygen species profiles also illustrated the improvement in combustion gas uniformity provided by the oxidant diffusion devices disclosed herein.

### EXAMPLE 3

### Analysis of Combustion Gas Profile Produced Using 8 Inch Choke Axial Tread Carbon Black Reactor without an Oxidant Diffusion Device

A combustion gas was prepared in a combustion zone of a conventional 8 inch choke axial flow tread carbon black reactor, such as that disclosed in U.S. Pat. Nos. 4,927,607 and 5,256,388 and depicted in FIG. 8. The reactor contained one fuel gas gun inserted from the front of the reactor to a position where the tip of the fuel gas gun was approximately under the center line of the 14 inch bustle inlet. The combustion zone was then operated at an air rate of approximately 7610 Nm³/hr; a natural gas fuel rate of approximately 507 Nm³/hr, an oxygen enrichment rate of 300 Nm³/hr and an air inlet temperature of approximately 510° C.

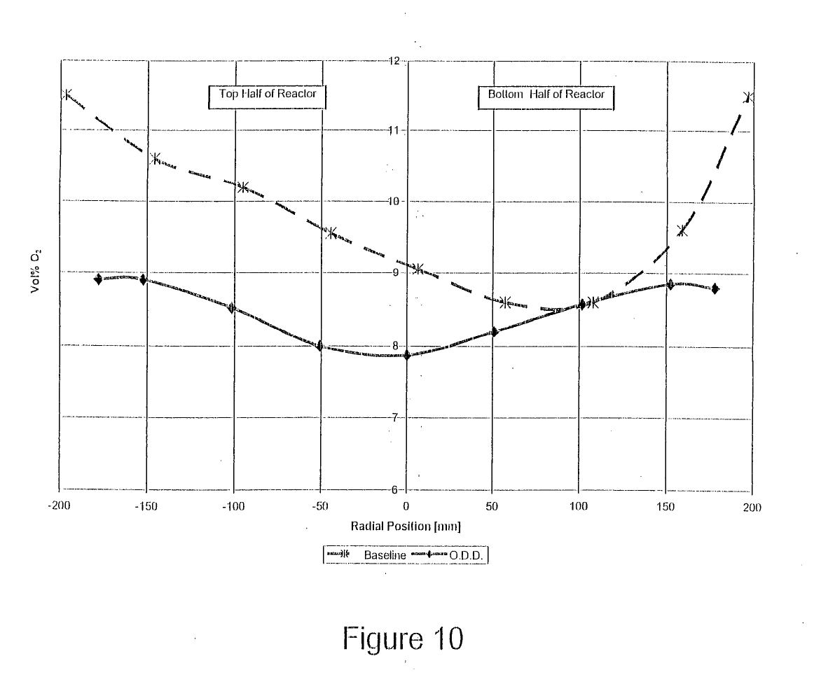

The uniformity of the combustion gas environment was analyzed immediately downstream from the combustion zone at the entrance to the reactor's choke section. More specifically, the concentration of oxygen in the combustion gas was measured by passing a water-cooled metal probe that aspirates combustion gas to a portable gas analyzer through the reactor's choke section oil-ports radially across a cylindrical cross section at +45° and −45° from vertical, forming an “X” pattern across the plane of interest located at the point of entrance to the choke section of the reaction zone. The measurements were obtained from r-values ranging from −8 inches to +8 inches across the diameter of the plane. The concentration of oxygen species is charted in FIG. 10 and is represented by the baseline graph. As depicted therein, the plot indicates that the maximum oxygen concentration difference in the combustion gas produced in a conventional reactor was approximately 3%.

### EXAMPLE 4

### Preparation of Combustion Gas Using 8 Inch Choke Axial Tread Carbon Black Reactor with the Oxidant Diffusion Device

A combustion gas was prepared in a combustion zone of a conventional 8 inch choke axial flow tread carbon black reactor modified by the insertion of an oxidant diffusion device as depicted in FIGS. 1-3. The reactor also contained four fuel introduction ports coaxially aligned with the four second axial oxidant inlet ports of the diffusion device and inserted from the front of the reactor to a position where the tip of the fuel gas gun was proximate to the exterior face of the oxidant diffusion device. The combustion zone was then operated at an air rate of 7350 Nm³/hr; a natural gas fuel rate of 490 Nm³/hr, an oxygen enrichment rate of 80 Nm³/hr and an air inlet temperature of approximately 570° C.

The uniformity of the combustion gas was analyzed immediately downstream from the combustion zone at the entrance to the reactor's choke section. More specifically, the concentration of oxygen species in the combustion gas was measured by passing a water-cooled metal probe that aspirates combustion gas to a portable gas analyzer through the reactor's choke section oil-ports radially across a cylindrical cross section at +45° and −45° from vertical, forming an “X” pattern across the plane of interest located at the entrance to the choke section of the reaction zone. The measurements were obtained from r-values ranging from −8 inches to +8 inches across the diameter of the plane. The concentration of oxygen species is charted in FIG. 10 and is represented by the graph labeled “O.D.D.” (meaning oxygen diffusion device). As depicted therein, the plot indicates that the maximum oxygen concentration difference in the combustion gas produced in a reactor modified by the use of an oxidant diffusion device was approximately 1%.

Furthermore, FIG. 10 illustrates that the concentration of oxygen species is generally lower toward the bottom of the reactor in those examples that did not utilize an oxidant diffusion device according the present disclosure. This is an expected variation that results as the velocity profile of the incoming air is skewed by turns in the upstream piping and the 90 degree turn in the bustle chamber itself. Additionally, an inadequate disbursement and subsequent mixing of the fuel and oxidant results from the introduction of the fuel through a single lance. As a result, the conventional axial tread reactor produces a non-uniform combustion gas pattern. In contrast however, the variation in oxygen species concentration measured in those examples using a oxidant diffusion device of the present disclosure provided a more uniform and thorough combustion gas environment, evidenced by the significantly smaller variation in oxygen species measured across the plane of the reactor.

### EXAMPLE 5

### Comparative Yield Analysis of an N330 Grade Carbon Black Produced Using a Conventional 8 Inch Choke Axial Tread Carbon Black Reactor Without an Oxidant Diffusion Device

An N330 grade carbon black was produced in a conventional 8 inch axial tread carbon black reactor similar to the reactor depicted in FIG. 8. The process conditions and percent yield are set forth below in Table 3.

TABLE 3

| | |
|---|---|
| Iodine No. | 85 |
| Blast Air Rate, Nm³/hr | 6650 |
| Blast Air Temperature, ° C. | 520 |
| Natural Gas Rate, Nm³/hr | 416 |
| Feedstock Oil Rate, Kg/hr | 1941 |
| Estimated Flame Temp. ° C. | 1731 |
| Blast Ratio | 16 |
| Total Yield (Kg CB/Kg Equiv. Oil) | .493 |

As indicated in Table 1, the process yielded 0.493 kg. of carbon black product per kilogram of carbon black feedstock.

### EXAMPLE 6

### Comparative Yield Analysis of N330 Grade Carbon Black Produced in an 8 Inch Axial Tread Carbon Black Reactor Modified by the Insertion of an Oxidant Diffusion Device Similar to that Depicted in FIGS. 1-3

An N330 grade carbon black was produced in an 8 inch axial tread carbon black reactor comprising an oxidant diffusion device similar to that depicted in FIGS. 1-3. The process conditions and percent yield are set forth below in Table 4.

TABLE 4

| | |
|---|---|
| Iodine No. | 85 |
| Blast Air Rate, Nm³/hr | 6650 |
| Blast Air Temperature, ° C. | 485 |
| Natural Gas Rate, Nm³/hr | 416 |
| Feedstock Oil Rate, kg/hr | 1920 |
| Estimated Flame Temp. ° C. | 1706 |
| Blast Ratio | 16 |
| Total Yield (kg CB/kg Equiv. Oil) | .513 |

As depicted in Table 2, the process utilizing the oxidant diffusion device produced a yield of 0.513 kg carbon black per kilogram of feedstock.

A comparison of the results obtained in Examples 5 and 6 illustrate that under substantially similar process conditions, the axial tread carbon black reactor containing the oxidant diffusion device and evaluated in Example 6 provided a percentage yield of carbon black product relative to carbonaceous feedstock that was approximately 4.1% higher than the reactor that did not contain the oxidant diffusion device, despite operating the reactor at a slightly reduced blast air temperature and correspondingly reduced oil/air ratio.

### EXAMPLE 7

### Analysis of Combustion Gas Profile Produced Using 8 Inch Choke Oil Fired Axial Tread Carbon Black Reactor without an Oxidant Diffusion Device

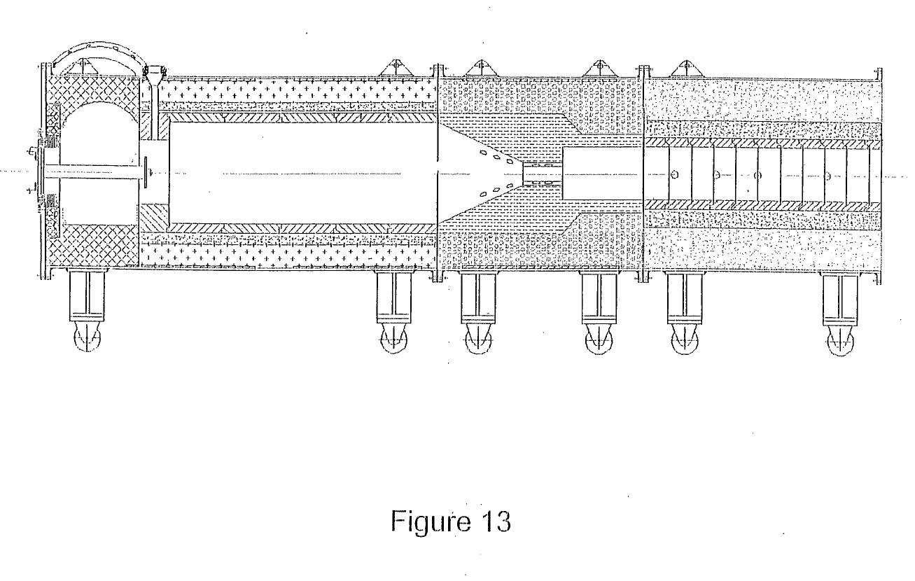

A combustion gas was prepared in a combustion zone of a conventional 8 inch choke axial flow tread carbon black reactor, such as that depicted in FIG. 13. The reactor contained one axial fuel oil gun inserted from the front face of the reactor to a position where the tip of the fuel oil gun was positioned approximately 180 mm downstream from the entrance of the combustion choke. The combustion zone was then operated under the following conditions:

| | Baseline (8″ reactor w/o |
|---|---|
| Case | insert & axial spray) |
| Iodine # | 101 |
| Blast Air Rate [Nm³/hr] | 8200 |
| Axial Air Rate [Nm³/hr] | 285 |
| Cooling Air Rate [Nm³/hr] | 244 |
| Total Air Rate [Nm³/hr] | 8729 |
| Atomizing Steam [kg/hr] | 210 |
| Blast Air Temperature [° C.] | 619 |
| Fuel Oil Rate [kg/hr] | 438 |
| Feedstock Oil Rate [kg/hr] | 2880 |
| Reactor Pressure [bar] | 0.451 |

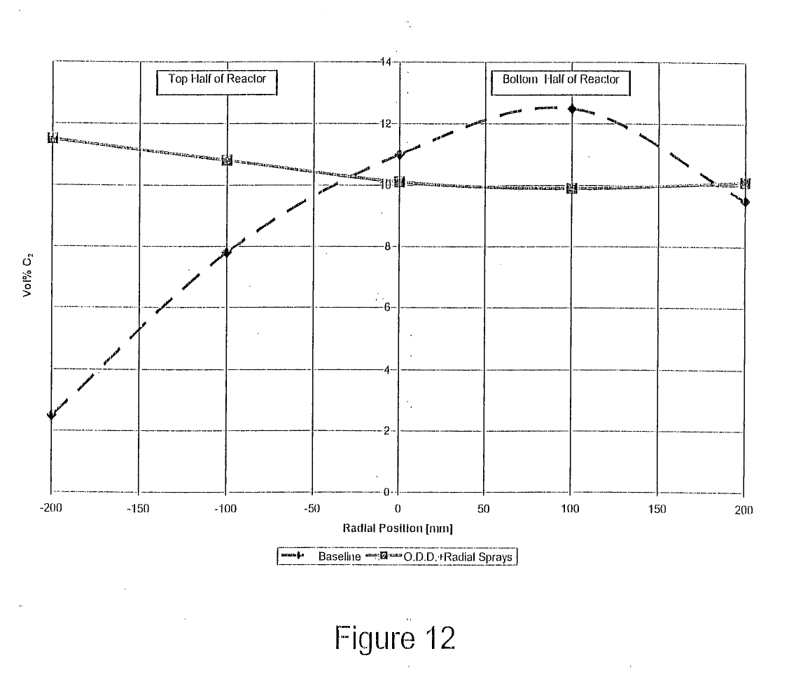

The uniformity of the combustion gas environment was analyzed immediately downstream from the combustion zone at the entrance to the reactor's choke section. The concentration of oxygen species in the combustion gas was measured by passing a water-cooled metal probe that aspirates combustion gas to a portable gas analyzer through the reactor's choke section oil-ports radially across a cylindrical cross section at +45° and −45° from vertical, forming an “X” pattern across the plane of interest. The measurements were obtained from r-values ranging from −8 inches to +8 inches across the diameter of the plane. The concentration of oxygen species is charted in FIG. 12 and is represented by the baseline graph. As depicted therein, the plot indicates that the maximum oxygen concentration difference in the combustion gas produced in a conventional reactor was approximately 10%.

Additionally, the experiment also provided the following carbon black yield and production rate data:

| | |
|---|---|
| Yield [kg CB/kg oil] | 0.486 |
| Production Rate [kg/hr] | 1507 |

### EXAMPLE 8

### Preparation of Combustion Gas Using 8 Inch Choke Axial Oil Fired Tread Carbon Black Reactor with the Oxidant Diffusion Device

A combustion gas was prepared in a combustion zone of a conventional 8 inch choke axial flow oil fired tread carbon black reactor modified by the insertion of an oxidant diffusion device depicted in FIGS. 5-6 and as also depicted in FIG. 8. The reactor contained three fuel oil introduction ports radially aligned and extending into the combustion choke, approximately 150 mm downstream from the proximal end of the oxidant diffusion. The combustion zone was then operated under the following conditions:

| | 8″ reactor w/insert, |
|---|---|
| Case | radial oil sprays in choke |
| Iodine # | 101 |
| Blast Air Rate [Nm³/hr] | 8266 |
| Blast Air Temperature [° C.] | 617 |
| Axial Air Rate [Nm³/hr] | 0 |
| Cooling Air Rate [Nm³/hr] | 415 |
| Total Air Rate [Nm³/hr] | 8681 |
| Atomizing Steam [kg/hr] | 0 |
| Fuel Oil Rate [kg/hr] | 436 |
| Feedstock Oil Rate [kg/hr] | 3030 |
| Reactor Pressure [bar] | 0.486 |

The uniformity of the combustion gas environment was analyzed immediately downstream from the combustion zone at the entrance to the reactor's choke section. The concentration of oxygen species in the combustion gas was measured by passing a water-cooled metal probe that aspirates combustion gas to a portable gas analyzer through the reactor's choke section oil-ports radially across a cylindrical cross section at +45° and −45° from vertical, forming an “X” pattern across the plane of interest. The measurements were obtained from r-values ranging from −8 inches to +8 inches across the diameter of the plane. The concentration of oxygen species is charted in FIG. 12 and is represented by the O.D.D. graph. As depicted therein, the plot indicates that the maximum oxygen concentration difference in the combustion gas produced in a conventional reactor was approximately 1.6%.

Additionally, the percentage yield of carbon black [kg CB/kg oil] increased by approximately 3.7 percent relative to the carbon black yield percentage produced in Example 7. Similarly, the rate of carbon black production increased by 306 kg/hr.

Throughout this application, various publications are referenced. The disclosures of these publications in their entireties are hereby incorporated by reference into this application in order to more fully describe the state of the art to which this invention pertains.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An oxidant diffusion device for use in a combustion zone of an axial tread carbon black reactor comprising: a housing having a central longitudinal axis and defining an internal cavity, comprising an open proximal end, an opposed distal end having an exterior face and an opposed interior face, and an exterior peripheral surface extending substantially between the proximal and distal ends of the housing, wherein the exterior peripheral surface of the housing defines a plurality of first oxidant inlet ports, the plurality of first oxidant inlet ports in fluid communication with the internal cavity of the housing, and wherein the distal end of the housing defines a plurality of second oxidant inlet ports extending from the exterior face to the interior face of the distal end, the plurality of second oxidant inlet ports in fluid communication with the internal cavity of the housing.

2. The oxidant diffusion device of claim 1, wherein the housing is substantially cylindrical.

3. The oxidant diffusion device of claim 1, wherein the housing is comprised of a ceramic material.

4. The oxidant diffusion device of claim 1, wherein the distal end of the housing has a peripheral circumferential flange that extends outwardly from the exterior face substantially parallel to the central longitudinal axis of the housing.

5. The oxidant diffusion device of claim 1, wherein the distal end comprises a male protrusion extending outwardly from the exterior face, the male protrusion defining a bore in fluid communication with the internal cavity.

6. The oxidant diffusion device of claim 5, wherein the male protrusion is substantially cylindrical, and wherein the male protrusion extends generally co-axial to the central longitudinal axis of the housing.

7. The oxidant diffusion device of claim 1, wherein the exterior peripheral surface of the housing has an arcuate flange extending outwardly from the exterior peripheral surface in a plane substantially transverse to the central longitudinal axis of the housing.

8. The oxidant diffusion device of claim 7, wherein the arcuate flange extends partially about the peripheral surface of the housing.

9. The oxidant diffusion device of claim 8, wherein the arcuate flange is positioned proximate the distal end of the housing.

10. The oxidant diffusion device of claim 1, wherein the plurality of first oxidant inlet ports are spaced apart about the exterior peripheral surface of the housing.

11. The oxidant diffusion device of claim 10, wherein the plurality of first oxidant inlet ports is positioned in a plane substantially transverse to the longitudinal axis of the housing.

12. The oxidant diffusion device of claim 11, wherein the plurality of first oxidant inlet ports are substantially uniformly spaced about the exterior peripheral surface.

13. The oxidant diffusion device of claim 12, wherein the plurality of first oxidant inlet ports comprises twelve first oxidant inlet ports that are spaced about 30 degrees apart circumferentially about the peripheral surface of the cup member.

14. The oxidant diffusion device of claim 11, wherein each first oxidant inlet port of the plurality of first oxidant inlet ports extends generally in a plane substantially transverse to the longitudinal axis of the housing.

15. The oxidant diffusion device of claim 1, wherein each second oxidant inlet port of the plurality of second inlet ports is spaced at substantially the same radial distance from the central longitudinal axis of the housing.

16. The oxidant diffusion device of claim 15, wherein each second oxidant inlet port of the plurality of second oxidant inlet ports are spaced substantially equally apart from each other.

17. The oxidant diffusion device of claim 16, wherein the plurality of second oxidant inlet ports comprises four second oxidant inlet ports that are spaced about 90 degrees apart circumferentially about the central longitudinal axis of the housing.

18. The oxidant diffusion device of claim 16, wherein distal end of the housing has a peripheral circumferential flange that extends from the exterior face substantially parallel to the central longitudinal axis of the housing, wherein the distal end of the housing has a male protrusion that extends outwardly from the exterior face generally co-axial to the central longitudinal axis of the housing, and wherein the plurality of second oxidant inlet ports are positioned therebetween the peripheral circumferential flange and the male protrusion.

19. The oxidant diffusion device of claim 1, wherein the interior face of the distal end of the housing member faces the internal cavity of the housing, wherein each second oxidant inlet port of the plurality of second oxidant inlet ports has a first portion proximate to the exterior face having a first cross-sectional area and a second portion proximate to the interior face having a second cross sectional area, and wherein the first cross-sectional area is less than the second cross sectional area.

20. The oxidant diffusion device of claim 19, wherein the second portion of the second oxidant inlet port tapers outwardly away from the end of the first portion of the second oxidant inlet port.

21. The oxidant diffusion device of claim 9, wherein the housing has a substantially upright axis, and wherein a portion of the arcuate flange is positioned in a plane extending through the upright axis and the central longitudinal axis of the housing.

22. An oxidant diffusion device for use in a combustion zone of an axial tread carbon black reactor, comprising: a housing member having a longitudinal axis and defining an internal cavity, comprising a distal end, an opposed open proximal end, and an exterior peripheral surface that defines a plurality of oxidant inlet ports positioned between the distal and proximal ends of the housing member, wherein each oxidant inlet port of the plurality of oxidant inlet ports is in fluid communication with the internal cavity of the housing member, and wherein the plurality of oxidant inlet ports are spaced apart about the exterior peripheral surface of the housing member and are positioned in a plane substantially transverse to the longitudinal axis of the housing member.

23. The oxidant diffusion device of claim 22, wherein the distal end and proximal end of the housing member each has a peripherally circumferential flange that extends outwardly and substantially transverse to the longitudinal axis of the housing member.

24. The oxidant diffusion device of claim 22, wherein the plurality of oxidant inlet ports are substantially uniformly spaced about the exterior peripheral surface.

25. The oxidant diffusion device of claim 24, wherein the plurality of oxidant inlet ports comprise eight oxidant inlet ports that are spaced about 45 degrees apart circumferentially about the exterior peripheral surface of the housing member.

26. The oxidant diffusion device of claim 22, wherein each oxidant inlet port of the plurality of oxidant inlet ports extends generally in a plane transverse to the longitudinal axis of the housing member.

27. The oxidant diffusion device of claim 22, wherein each oxidant inlet port of the plurality of oxidant inlet ports has a generally rectangular shape that has four corners.

28. The oxidant diffusion device of claim 27, wherein each corner of the rectangular shaped oxidant inlet port has a curved radius.

29. The oxidant diffusion device of claim 27, wherein each oxidant inlet port has a substantially equal cross-sectional area.

30. The oxidant diffusion device of claim 27, wherein the housing member has a substantially upright axis, wherein a portion of a first oxidant port of the plurality of oxidant inlet ports is positioned in a plane that extends through the upright axis and the longitudinal axis of the housing, and wherein the first oxidant port has a cross-sectional area that is less than the cross-sectional area of the remaining oxidant ports.

31. The oxidant diffusion device of claim 22, wherein the housing member is comprised of a ceramic material.

32. The oxidant diffusion device of claim 22, wherein the housing member is substantially cylindrical.

33. The oxidant diffusion device of claim 22, wherein the distal end is closed.

34. A combustion system for producing a combustion gas in an axial tread carbon black reactor having, in fluid communication from upstream to downstream, a bustle, a bustle chamber, and a combustion chamber, comprising:
an oxidant diffusion device comprising a housing having a central longitudinal axis and defining an internal cavity, comprising an open proximal end, an opposed distal end having an exterior face and an opposed interior face, and an exterior peripheral surface extending substantially between the proximal and distal ends of the housing, wherein the exterior peripheral surface of the housing defines a plurality of first oxidant inlet ports, the plurality of first oxidant inlet ports in fluid communication with the internal cavity of the housing and the bustle, wherein the distal end of the housing defines a plurality of second oxidant inlet ports extending from the exterior face to the interior face of the distal end, the plurality of second oxidant inlet ports in fluid communication with the internal cavity of the housing and the bustle, and wherein the proximal end of the housing is in fluid communication with the combustion chamber; and
a fuel inlet assembly constructed and arranged for insertion into at least one second oxidant inlet port of the plurality of second oxidant inlet ports.

35. The combustion system of claim 34, wherein the housing is substantially cylindrical.

36. The combustion system of claim 34, wherein the housing is comprised of a ceramic material.

37. The combustion system of claim 34, wherein the distal end of the housing has a peripheral circumferential flange that extends outwardly from the exterior face substantially parallel to the central longitudinal axis of the housing.

38. The combustion system of claim 34, wherein the distal end comprises a male protrusion extending outwardly from the exterior face, the male protrusion defining a bore in fluid communication with the internal cavity.

39. The combustion system of claim 38, wherein the male protrusion is substantially cylindrical, and wherein the male protrusion extends generally co-axial to the central longitudinal axis of the housing.

40. The combustion system of claim 34, wherein the exterior peripheral surface of the housing has an arcuate flange extending outwardly from the exterior peripheral surface in a plane substantially transverse to the central longitudinal axis of the housing.

41. The combustion system of claim 40, wherein the arcuate flange extends partially about the peripheral surface of the housing.

42. The combustion system of claim 41, wherein the arcuate flange is positioned proximate the distal end of the housing.

43. The combustion system of claim 34, wherein the plurality of first oxidant inlet ports are spaced apart about the exterior peripheral surface of the housing.

44. The combustion system of claim 43, wherein the plurality of first oxidant inlet ports is positioned in a plane substantially transverse to the longitudinal axis of the housing.

45. The combustion system of claim 44, wherein the plurality of first oxidant inlet ports are substantially uniformly spaced about the exterior peripheral surface.

46. The combustion system of claim 45, wherein the plurality of first oxidant inlet ports comprises twelve first oxidant inlet ports that are spaced about 30 degrees apart circumferentially about the peripheral surface of the cup member.

47. The combustion system of claim 44, wherein each first oxidant inlet port of the plurality of first oxidant inlet ports extends generally in a plane substantially transverse to the longitudinal axis of the housing.

48. The combustion system of claim 34, wherein each second oxidant inlet port of the plurality of second inlet ports is spaced at substantially the same radial distance from the central longitudinal axis of the housing.

49. The combustion system of claim 48, wherein each second oxidant inlet port of the plurality of second oxidant inlet ports are spaced substantially equally apart from each other.

50. The combustion system of claim 49, wherein the plurality of second oxidant inlet ports comprises four second oxidant inlet ports that are spaced about 90 degrees apart circumferentially about the central longitudinal axis of the housing.

51. The combustion system of claim 49, wherein the distal end of the housing has a peripheral circumferential flange that extends from the exterior face substantially parallel to the central longitudinal axis of the housing, wherein the distal end of the housing has a male protrusion that extends outwardly from the exterior face generally co-axial to the central longitudinal axis of the housing, and wherein the plurality of second oxidant inlet ports are positioned therebetween the peripheral circumferential flange and the male protrusion.

52. The combustion system of claim 34, wherein the interior face of the distal end of the housing member faces the internal cavity of the housing, wherein each second oxidant inlet port of the plurality of second oxidant inlet ports has a first portion proximate to the exterior face having a first cross-sectional area and a second portion proximate to the interior face having a second cross sectional area, and wherein the first cross-sectional area is less than the second cross sectional area.

53. The combustion system of claim 52, wherein the second portion of the second oxidant inlet port tapers outwardly away from the end of the first portion of the second oxidant inlet port.

54. The combustion system of claim 42, wherein the housing has a substantially upright axis, and wherein a portion of the arcuate flange is positioned in a plane extending through the upright axis and the central longitudinal axis of the housing.

55. A combustion system for producing a combustion gas in an axial tread carbon black reactor having, in fluid communication from upstream to downstream, a bustle, a bustle chamber, and a combustion chamber, comprising:
an oxidant diffusion device comprising: a housing member having a longitudinal axis and defining an internal cavity, the housing member having a distal end, an opposed open proximal end, and an exterior peripheral surface that defines a plurality of oxidant inlet ports positioned between the distal and proximal ends of the housing member, wherein each oxidant inlet port of the plurality of oxidant inlet ports is in fluid communication with the internal cavity of the housing member and the bustle, wherein the plurality of oxidant inlet ports are spaced apart about the exterior peripheral surface of the housing member and are positioned in a plane substantially transverse to the longitudinal axis of the housing member, and wherein the proximal end of the housing member is in fluid communication with the combustion chamber; and
a fuel inlet assembly constructed and arranged for insertion into the bustle chamber.

56. The combustion system of claim 55, wherein the distal end and proximal end of the housing member each has a peripherally circumferential flange that extends outwardly and substantially transverse to the longitudinal axis of the housing member.

57. The combustion system of claim 55, wherein the plurality of oxidant inlet port are substantially uniformly spaced about the exterior peripheral surface.

58. The combustion system of claim 57, wherein the plurality of oxidant inlet ports comprise eight oxidant inlet ports that are spaced about 45 degrees apart circumferentially about the exterior peripheral surface of the housing member.

59. The combustion system of claim 55, wherein each oxidant inlet port of the plurality of oxidant inlet ports extends generally in a plane transverse to the longitudinal axis of the housing member.

60. The combustion system of claim 55, wherein each oxidant inlet port of the plurality of oxidant inlet ports has a generally rectangular shape that has four corners.

61. The combustion system of claim 60, wherein each corner of the rectangular shaped oxidant inlet port has a curved radius.

62. The combustion system of claim 60, wherein each oxidant inlet port has a substantially equal cross-sectional area.

63. The combustion system of claim 60, wherein the housing member has a substantially upright axis, wherein a portion of a first oxidant port of the plurality of oxidant inlet ports is positioned in a plane that extends through the upright axis and the longitudinal axis of the housing, and wherein the first oxidant port has a cross-sectional area that is less than the cross-sectional area of the remaining oxidant ports.

64. The combustion system of claim 55, wherein the housing member is comprised of a ceramic material.

65. The combustion system of claim 55, wherein the housing member is substantially cylindrical.

66. The combustion system of claim 55, wherein the distal end is closed.

67. A method for producing a combustion gas in an axial tread carbon black reactor having, in fluid communication from upstream to downstream, a bustle, bustle chamber and a combustion section, comprising:
a) introducing an oxidant flow into the bustle chamber of an axial tread carbon black reactor, wherein the bustle chamber comprises a fuel introduction assembly and an oxidant diffusion device, wherein the oxidant diffusion device comprises a housing having a central longitudinal axis and defining an internal cavity, the housing having an open proximal end, an opposed distal end, and an exterior peripheral surface extending substantially between the proximal and distal ends of the housing, wherein the exterior peripheral surface of the housing defines a plurality of first oxidant inlet ports, the plurality of first oxidant inlet ports in fluid communication with the internal cavity of the housing;
b) introducing a fuel into the oxidant diffusion device; and
c) combusting the oxidant and the fuel to provide a combustion gas.

68. The method of claim 67, wherein the distal end is closed and has an upstream exterior face and an opposed downstream interior face, and wherein the distal end defines a plurality of second oxidant inlet ports extending between the exterior face and the interior face in fluid communication with the bustle and the internal cavity.

69. The method of claim 67, wherein the combustion gas provided by step c) has an oxygen species gradient less than or equal to approximately 1.5 volume percent when measured downstream from the bustle chamber.

70. The method of claim 67, wherein the plurality of first oxidant inlet ports provide a first directional oxidant flow and wherein the plurality of second oxidant inlet ports provide a second directional oxidant flow.

71. The method of claim 70, wherein the ratio of the sum of the flow volume of the second directional oxidant flow currents to the sum of the flow volume of the first directional oxidant flow currents is in the range of from approximately 3:2 to approximately 4:1.

72. The method of claim 71, wherein the ratio of the sum of the flow volume of the second oxidant flow currents to the sum of the flow volume of the first oxidant flow currents is approximately 3:1.

73. A process for the production of carbon black in an axial flow tread carbon black reactor, comprising:
a) producing a combustion gas stream having an oxygen species gradient less than or equal to approximately 1.5 volume percent;
b) reacting a carbon black yielding carbonaceous feedstock with the combustion gas stream of step a) to form a reaction stream containing carbon black; and
c) quenching, cooling, separating and recovering the carbon black formed by the process of steps a) and b).

74. The process of claim 73, wherein step a) is carried out by providing at least one axial oxidant flow current and at least one radial oxidant flow current in a bustle chamber of an axial tread carbon black reactor, introducing a fuel into the oxidant diffusion device, and combusting the oxidant and the fuel to provide the combustion gas.

75. The process of claim 74, wherein the ratio of the sum of the flow volume of the axial oxidant flow currents to the sum of the flow volume of the radial oxidant flow currents is in the range of from approximately 3:2 to approximately 4:1.

76. The process of claim 72, wherein the ratio of the sum of the flow volume of the axial oxidant flow currents to the sum of the flow volume of the radial oxidant flow currents is approximately 3:1.
